(19) United States
(12) Patent Application Publication
(10) Pub. No.: US 2005/0238818 A1
(43) Pub. Date: Oct. 27, 2005

(54) Plasma processing method and plasma processing apparatus

(75) Inventor: Tatsuya Yoshizawa, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Corporation

(21) Appl. No.: 11/033,958

(22) Filed: Jan. 12, 2005

(30) Foreign Application Priority Data
Jan. 14, 2004 (JP) 2004-006550

(51) Int. Cl. H05H 1/24

(52) U.S. Cl. 427/569; 156/345.47; 156/345.51

(57) ABSTRACT

A plasma processing method and a plasma processing apparatus. The plasma processing method includes: a placing process for placing the electrode material layer between a pair of electrodes formed in a vacuum chamber; a gas supply process for supplying a plasma processing gas into the vacuum chamber; and a electric field setting process for applying a main AC voltage superimposed on a reference voltage to one of the pair of electrodes via a capacitor and for keeping the other electrode at the reference potential. The placing process includes a process for locating the electrode material layer to be closer to the other electrode than to the one electrode. Moreover, the electric field setting process may include a process for applying an additional AC voltage having a lower frequency than a frequency of the main AC voltage between the other electrode and the reference potential.

### BACKGROUND OF THE INVENTION

1. Field of the Invention

The present invention relates to a plasma processing method and apparatus for applying a plasma treatment on a surface of an electrode.

2. Description of the Related Art

An organic electroluminescence device (hereinafter, simply referred to as an organic EL device) is known one of an electric device wherein an organic functional layer being made of an organic material and having a predetermined function is provided to be in contact with an electrode material layer made of a conductive material such as a metal and a metal oxide.

The organic EL device includes the organic functional layer sandwiched between an anode and a cathode. The organic functional layer includes a light-emitting layer having electro-luminescence characteristics and is made of an organic compound. The organic functional layer is either a single layer structure including the light-emitting layer only or a multilayer structure such as a three-layer structure including a hole transport layer, the light-emitting layer, and an electron transport layer.

By applying a voltage across the anode and the cathode of the organic EL device having the aforementioned structure, holes are injected from the anode to the organic functional layer while electrons are injected from the cathode to the organic functional layer. The holes are recombined with the electrons inside the organic functional layer to give luminescence.

The organic functional layer is made of an organic material having a light emitting function and a charge transport function. The efficiency at which the function of the organic functional layer such as the aforementioned light-emitting functional layer of the organic EL device depends on the efficiency of injection of carriers from the electrode material layer to the organic functional layer. That injection efficiency depends on cleanliness of a surface of the electrode material layer and on a work function of the electrode layer.

Thus, in a case of the organic EL device, after the anode having a predetermined pattern has been formed, the surface of the anode is subjected to a surface treatment such as a plasma process in order to improve the luminescence properties, in a fabrication process of the organic EL device (see Japanese Patent kokai No. 7-142168).

When the surface of the anode is processed as described above, contaminants such as particles of organic materials adhering to the surface of the anode are removed. In addition, the surface of the anode is oxidized so as to be modified, so that the work function is increased. However, even if the aforementioned plasma process is performed for the surface of the anode, further improvement of the properties of the organic functional layer is demanded.

Problems to be solved by the present invention include the aforementioned problem.

### SUMMARY OF THE INVENTION

According to a first aspect of the present invention, a plasma processing method for performing a plasma process for a surface of an electrode material layer that is to be in contact with an organic functional layer, comprises: a placing process for placing the electrode material layer between a pair of electrodes formed in a vacuum chamber; a gas supply process for supplying a plasma processing gas into the vacuum chamber; and a electric field setting process for applying a main AC voltage superimposed on a reference voltage to one of the pair of electrodes via a capacitor and for keeping the other electrode at the reference potential in the vacuum chamber, wherein the placing process including a process for locating the electrode material layer to be closer to the other electrode than to the one electrode.

According to another aspect of the present invention, a plasma processing apparatus for processing a surface of an electrode material layer that is to be in contact with an organic functional layer by plasma, comprises: a holding unit for holding an object having the electrode material layer on a surface thereof in a vacuum chamber; a gas supply unit for supplying a plasma processing gas into the vacuum chamber; at least two electrodes provided near the holding unit; and a application unit for applying a main AC voltage across one of the electrodes and a reference potential via a capacitor while keeping the other of the electrodes at the reference potential, wherein the holding unit holds the object in such a manner that the object is located at a position closer to the other electrode.

### BRIEF DESCRIPTION OF THE DRAWINGS

FIG. 1 shows a cross-sectional view of a plasma processing apparatus according to the present invention;

FIG. 2 shows a cross-sectional view of a main part of the plasma processing apparatus shown in FIG. 1 and a graph of a potential distribution while plasma is generated;

FIG. 3 shows a cross-sectional view of a modified embodiment of the plasma processing apparatus according to the present invention;

FIG. 4 shows a cross-sectional view of a modified embodiment of the plasma processing apparatus according to the present invention;

FIG. 5 shows a cross-sectional view of a modified embodiment of the plasma processing apparatus according to the present invention;

FIGS. 6A to 6E show cross-sectional views showing a fabrication procedure of an organic EL device according to the present invention;

FIGS. 7A and 7B show cross-sectional views showing steps in the fabrication procedure of the organic EL device according to the present invention, which follow the steps shown in FIGS. 6A to 6E; and

FIG. 8 shows a graph of a relationship between an applied voltage and luminance for an organic EL device of Example and that of Comparative Example.

### DETAILED DESCRIPTION OF THE INVENTION

A plasma processing method and a plasma processing apparatus according to an embodiment of the present invention will now be described in detail, referring to the accompanying drawings.

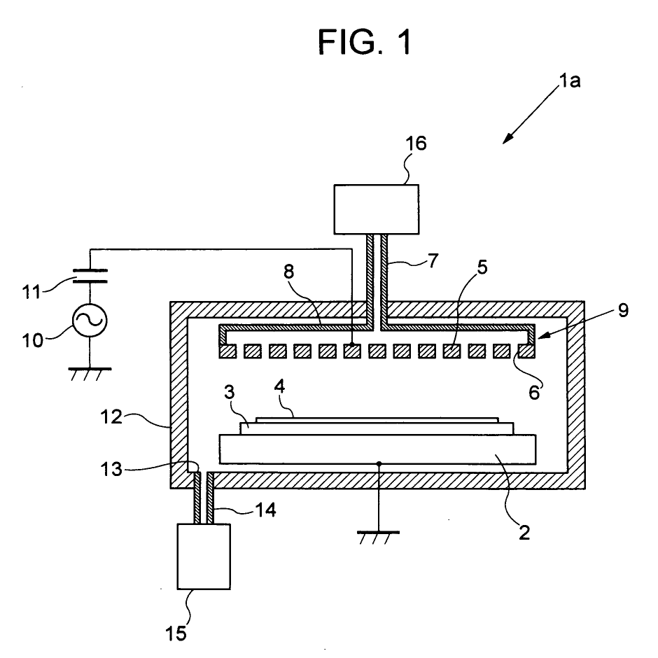

As shown in FIG. 1, a plasma processing apparatus 1a includes a first electrode 2 connected to a reference potential. The reference potential may be a ground potential. The first electrode 2 can support a substrate 3 for an organic EL device being made of glass or resin. On the substrate 3, an anode layer 4 having a pattern is formed. The anode layer 4 is made of conductive material having a large work function, for example, indium tin oxide (hereinafter, simply referred to as ITO) or indium zinc oxide. The first electrode 2 may be provided with holding unit (not shown) that locates the substrate 3 near the first electrode 2 and holds the substrate 3. The holding unit may use a holder for placing the substrate thereon.

A second electrode 5 is provided to be away from and opposed to the first electrode 2. The second electrode 5 has a mesh-like shape in which a plurality of holes 6 are evenly distributed. The second electrode 5 is supported by an insulation member 8 having a supplying pipe 7, and forms a part of a shower head 9. The second electrode 5 is connected to one end of a first power supply 10 connected to the reference potential at another end, via a capacitor 11. The frequency of the first power supply 10 is on the order of MHz, for example, 13.56 MHz. The reference potential may be a ground potential.

The first electrode 2 and the second electrode 5 are provided in a vacuum chamber 12. In the wall of the vacuum chamber 12, an exhaust vent 13 is provided, so that the vacuum chamber 12 is connected to an exhaust pipe 14 through the exhaust vent 13. The exhaust pipe 14 is connected to pressure-reducing unit 15 reducing the pressure in the vacuum chamber. The pressure-reducing unit 15 includes an exhaust pump such as a turbomolucular pump or a dry pump. The vacuum chamber 12 is also connected to gas supply unit 16 for supplying a plasma processing gas through the supply pipe 7 of the shower head 9. The plasma processing gas is supplied to the inside of the vacuum chamber 12 by passing through the holes 6 provided in the second electrode 5. In other words, the holes 6 serve as supply ports for supplying the plasma processing gas. The plasma processing gas may be used the mixture gas of oxygen and any of nitrogen, argon, helium, neon, xenon, and halogen can be used, for example.

A method for generating plasma by excitation by using the aforementioned plasma processing apparatus 1a in which the first electrode 2 for supporting the substrate 3 is grounded and the second electrode 5 is connected to the first power supply 10 via the capacitor 11, is called as an “anode coupling method.” A plasma process using the plasma processing apparatus of that anode coupling method is achieved by placing the substrate 3 having the anode layer 4 formed thereon on the first electrode 2 in the vacuum chamber 12 under a reduced pressure, then supplying a plasma processing gas into the vacuum chamber 12 and applying a high-frequency voltage across the first and second electrodes.

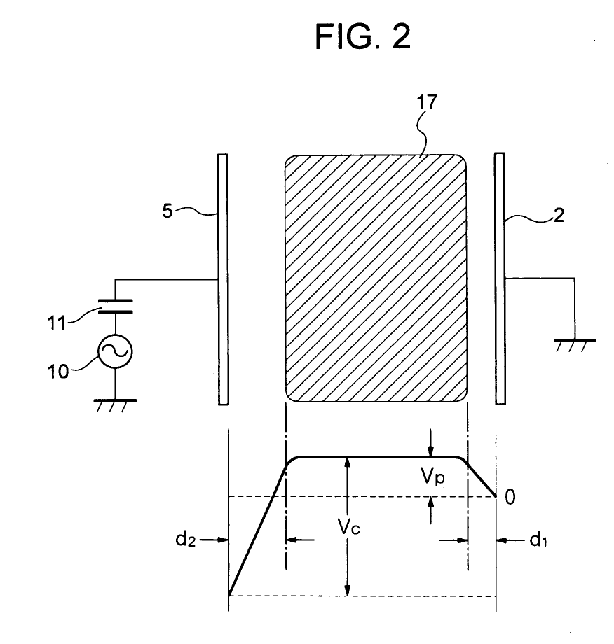

As shown in FIG. 2, plasma 17 is generated between the first electrode 2 and the second electrode 5 by applying a high-frequency voltage to an atmosphere of plasma processing gas. The plasma 17 is at a positive potential with respect to the first electrode 2 and the second electrode 5. An average potential difference (V_{c}) between the plasma and the second electrode 5 is larger than an average potential difference (Vₚ) between the plasma and the first electrode 2 (V_{c}>Vₚ) because of capacity coupling by the capacitor. That is, the second electrode 5 is at a negative potential with respect to the first electrode 2. On the front surfaces (the surfaces facing the plasma) of the first and second electrodes 2 and 5, ion sheaths having widths of d₁ and d₂, respectively, are formed. The width of the ion sheath on the first electrode 2 is smaller than that on the second electrode 5 connected to the first power supply (d₂>d₁).

Reactive ion species in the plasma reach the anode layer 4 due to the potential difference between the plasma and the first electrode 2, so as to chemically react with organic contaminants (residue of resist used in pattern formation of the anode layer, for example) existing on the anode layer 4. As a result, the organic contaminants are decomposed into gas of carbon dioxide and water vapor and are removed. The reactive ion species also react with the anode layer 4, and thus cause modification of the anode layer 4 such as oxidization of the anode layer 4.

In the aforementioned plasma process, physical reaction in which ions collide with the surface of the anode layer 4 also occurs simultaneously. This physical reaction occurs because ions in the plasma are accelerated by the potential difference between the first electrode 2 and the plasma and the accelerated ions are incident on the anode layer 4. The surface of the anode layer 4 is sputtered by this physical reaction. Therefore contaminants that cannot be removed by reaction with the reactive ion species, for example, inorganic contaminants, can be removed from the surface of the anode layer 4.

However, the plasma process having a large effect of the physical reaction is not preferable. When the effect of the physical reaction becomes larger, the surface of the anode layer 4 becomes rough because of collision with ions and the work function of the anode layer 4 decreases. Thus a driving voltage of the organic EL device increases and the luminance reduces. In addition, in a region of the substrate that is not covered by the anode layer 4, collision with ions damages the surface of the substrate. The substrate having the damaged surface is easy to break.

The plasma process having a large effect of the physical reaction is conducted in case of using a plasma processing apparatus of a cathode coupling method. The plasma processing apparatus of a cathode coupling method has a supporting electrode for supporting a substrate connected to a first power supply via a capacitor and a ground electrode opposed to the supporting electrode. In such the plasma processing apparatus of the cathode coupling method, when a high-frequency voltage is applied to an atmosphere of plasma processing gas to generate plasma, the plasma is at a positive potential with respect to the supporting electrode and the ground electrode, and an average potential difference between the plasma and the supporting electrode is larger than a potential difference between the plasma and the ground electrode. When ions in the plasma are incident toward an electrode, the incident energy of ions in the plasma is in proportion to the potential difference. Therefore, ions having a large incident energy collide with a substrate placed on the supporting electrode and an anode layer on the substrate. As a result, in the plasma process using the plasma processing apparatus of the cathode coupling method, the substrate and the anode layer are damaged by collision with ions.

On the other hand, in case of conducting a plasma process using the plasma processing apparatus of the anode coupling method, the potential difference between the first electrode for supporting the substrate and the plasma is smaller than that between the second electrode and the plasma. Thus, the incident energy of ions becomes smaller. Therefore, the plasma process in which the physical reaction has small effects while the chemical reaction has large effects can be conducted. As a result, it is possible to chemically remove contaminants from the surface of the anode layer and modify the surface of the anode layer.

In the above embodiment, the plasma processing gas is supplied into the vacuum chamber through a plurality of holes provided in the second electrode. This structure allows the plasma processing gas to be uniformly distributed between the first electrode and the second electrode. Therefore, it is possible to make plasma density uniform. Moreover, a flow of ions can be controlled by the flow of plasma processing gas in such a manner that ions flow along a direction vertical to the anode layer. Therefore, it is possible to conduct the plasma process uniformly for the surface of the anode layer. Please note that the second electrode is not limited to the mesh-like conductive member having a plurality of holes evenly provided. The second electrode may be a porous conductive member, for example.

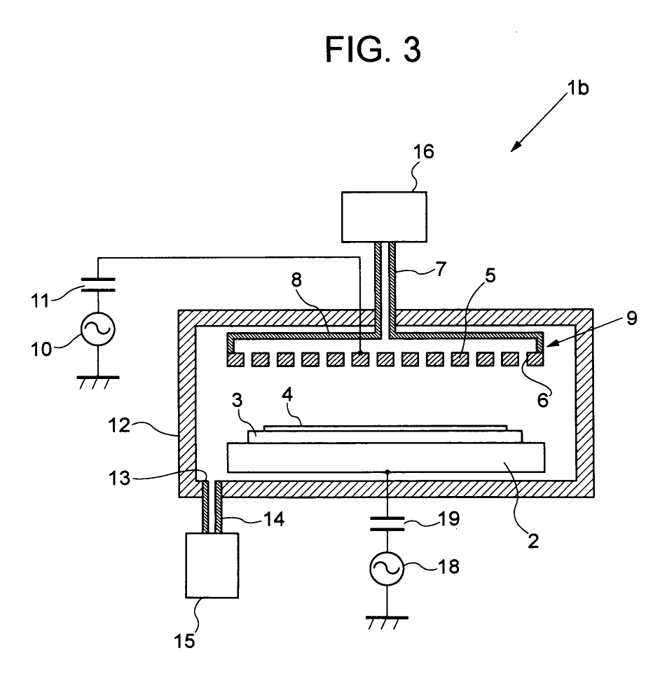

In a modified embodiment, as shown in FIG. 3, the first electrode 2 of a plasma processing apparatus 1b may be connected to one end of the second power supply 18 connected at another end to the reference potential, via a capacitor 19. Except for the above, the structure of the plasma processing apparatus 1b is approximately the same as that of the plasma processing apparatus 1a shown in FIG. 1. The frequency of the second power supply 18 is lower than that of the first power supply 10 and is on the order of KHz to MHz. For example, the frequency of the second power supply 18 is 100 KHz. According to the structure shown in FIG. 3, it is possible to adjust the magnitude of the incident energy of the ions incident on the anode layer on the substrate supported by the first electrode by varying the potential at the first electrode.

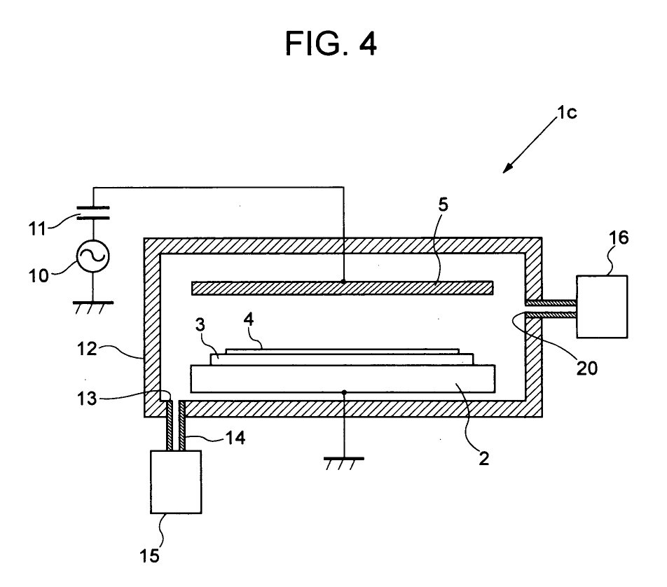

According to a modified embodiment, it is not always that the supply port of the plasma processing gas is provided in the second electrode. For example, as shown in FIG. 4, in order to supply the plasma processing gas to a space between the first electrode 2 and the second electrode 5, a plasma processing apparatus 1c may include a supply port 20 of the plasma processing gas in the wall of the vacuum chamber 12, so that the plasma processing gas is supplied from the gas supply unit 16 through the supply port 20. The second electrode 5 may have no hole. Except for the above, the structure of the plasma processing apparatus 1c is approximately the same as that of the plasma processing apparatus 1a shown in FIG. 1. According to the structure shown in FIG. 4, the flow of plasma processing gas can be adjusted by the positions of the supply port 20 and the exhaust vent 13.

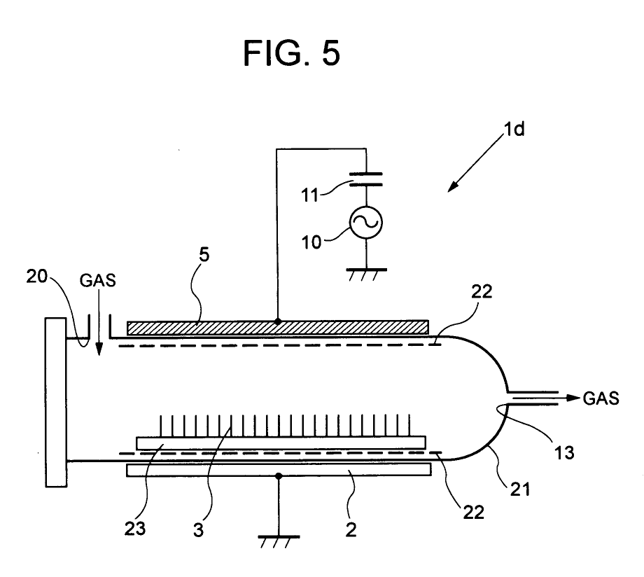

The plasma processing apparatus is not limited to the above-described structure, i.e., a so-called parallel-plate type plasma processing apparatus. For example, a barrel-type plasma processing apparatus 1d shown in FIG. 5 may be used. The barrel-type plasma processing apparatus 1d includes the first electrode 2 and the second electrode 5. The first electrode 2 is connected to a reference potential. The second electrode 5 is connected to one end of the first power supply 10 that is connected to the reference potential at the other end, via a capacitor 11. The reference potential may be a ground potential. A tube 21 made of quartz is provided between the first and second electrodes. In the tube 21, a cylindrical etching tunnel 22 having a plurality of holes is provided. The etching tunnel 22 can support a holder 23 therein, on which a plurality of substrates 3 can be placed. The substrate 3 has an anode layer (not shown) formed thereon. The holder 23 is supported at a position closer to the first electrode 2 than to the second electrode 5, so that the substrate 3 is supported to be close to the first electrode 2.

The tube 21 is provided with a supply port 20 of plasma processing gas and an exhaust vent 13 for exhausting gas in the tube 21. The plasma processing gas is supplied from gas supply unit (not shown) to the inside of the tube 21 through the supply port 20, and the gas inside the tube 21 is exhausted by exhaust unit (not shown) through the exhaust vent 13.

In case of conducting a plasma process using the plasma processing apparatus having the structure mentioned above, by holding the substrate at a position closer to the first electrode, the plasma process wherein the effects of the chemical reaction are larger than those of the physical reaction can be conducted for the anode layer. Moreover, since a plurality of substrates can be processed by plasma simultaneously, throughput of the plasma processing apparatus can be increased.

Next, a fabrication method of an organic EL device using the aforementioned plasma processing apparatus is described.

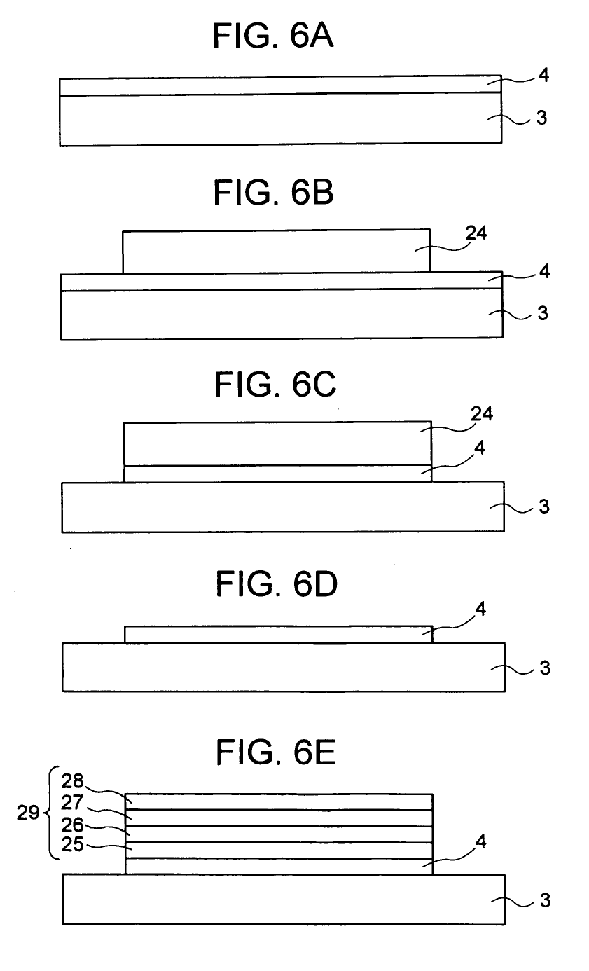

As shown in FIG. 6A, an anode layer 4 is deposited on a substrate 3 made of glass, resin or the like, by sputtering, for example. The anode layer 4 is made of a conductive material having a large work function, such as ITO.

After the formation of the anode layer 4, a resist layer 24 having a predetermined pattern is formed on the anode layer 4 by a typical photolithography process (FIG. 6B). Then, the anode layer 4 may be etched by using the resist 24 as a mask (FIG. 6C). This etching is achieved by wet etching or dry etching.

The wet etching uses hydrochloric acid solution of ferric chloride, oxalic acid, halogen acid such as hydrochloric acid, and hydroiodic acid, or nitrohydrochloric acid as etchant.

The dry etching may be plasma etching using an etching gas such as CH₄, HCl, HBr, Hl, C₂H₅l, Br₂ or I₂. Plasma etching process is conducted by using a parallel-plate type plasma etching apparatus, for example. Moreover, as the dry etching, reactive ion etching (RIE) using a mixture gas of hydrogen halide such as hydrogen iodide and an inert gas such as helium gas may be applied.

After the etching process, the resist is removed from the substrate. As a resist removing method, a wet process and a dry process can be applied. In the wet process, alkaline resist remover, developing agent (in a case of performing exposure or the entire surface of the substrate) can be applied. In the dry process, a plasma ashing process, an ozone ashing process, and the like can be applied.

The plasma ashing process is a process for causing reaction of gas having been changed into plasma with resist so as to decompose and remove the resist. The plasma is generated by applying a high-frequency voltage to an atmosphere gas such as oxygen. In case where the atmosphere gas is oxygen gas or a mixed gas containing oxygen, the generated plasma is called as oxygen plasma. The resist reacted with the oxygen plasma is decomposed into gas such as carbon dioxide and water vapor, and is removed.

The ozone ashing process is a process for causing reaction of ozone gas with resist so as to decompose and remove the resist. The ozone gas is generated by irradiating an oxygen atmosphere gas with ultraviolet (UV) light, for example. Oxygen radicals in the reactive gas having been generated by the decomposition of the ozone gas react with the resist, so that the resist is decomposed into gas such as carbon dioxide or water vapor, and is removed.

The resist is removed by performing the aforementioned process, so that an anode layer 4 having a pattern is obtained (FIG. 6D). It is preferable that all processes to be performed after the removal of the resist be performed under a reduced pressure without exposing the anode layer 4 to atmospheric air. This is because it is possible to prevent contaminants (particles of organic materials or moisture, for example) from atmospheric air from adhering to the surface of the anode layer 4.

After the formation of the pattern of the anode layer, a plasma processing process for irradiating the surface of the anode layer with plasma is performed, for example, by means of the plasma processing apparatus as shown in FIG. 1.

The plasma processing process includes: a placing process for placing the electrode material layer between a pair of electrodes formed in a vacuum chamber; a gas supply process for supplying a plasma processing gas into the vacuum chamber; and a electric field setting process for applying a main AC voltage superimposed on a reference voltage to one of the pair of electrodes via a capacitor and for keeping the other electrode at the reference potential in the vacuum chamber. Please note that the above placing of the anode layer places the anode layer so as to be closer to the other electrode than to the one electrode. A mixture gas of oxygen and any of nitrogen, argon, helium, neon, xenon, and halogen can be used as the plasma processing gas.

When the aforementioned plasma process is performed to the surface of the anode layer, reactive ion species in the plasma and organic contaminants on the anode layer such as residue of the resist react with each other. As a result, the organic contaminants are decomposed into carbon dioxide and water and are removed. Moreover, the reactive ion species also reacts with the anode layer, thus causing the modification of the anode layer such as oxidization of the anode layer. In addition, physical reaction wherein ions in the plasma collide with the surface of the anode layer occurs simultaneously. Therefore, inorganic contaminants that cannot be removed by reaction with the reactive ion species are sputtered to be removed from the surface of the anode layer.

As shown in FIG. 6E, on the anode layer 4 having been subjected to the aforementioned plasma process, a hole injection layer 25, a hole transport layer 26, a light-emitting layer 27, and an electron injection-transport layer 28 are sequentially deposited in that order by vapor deposition, for example. Thus, an organic functional layer 29 is obtained.

Examples of a material for the hole injection layer 25 are phthalocyanine complexes such as copper phthalocyanine, and aromatic amine derivatives such as 4,4′,4″-tris(3-methylphenylphenylamino) triphenylamine or the like. Other than the above, hydrazone derivatives, carbazole derivatives, triazole derivatives, imidazole derivatives, oxadiazole derivatives containing amino groups, polythiophene or the like may be also used as the material for the hole injection layer.

Examples of a material for the hole transport layer 26 are aromatic amine derivatives such as N,N′-diphenyl-N,N′-di(3-methylphenyl) 4,4′-diaminobiphenyl (TPD) and NPB (4,4′-bis[N-(1-naphthyl)-N-phenylamino]biphenyl.

Examples of a material for the light-emitting layer 27 are metal-complex pigments such as tris(8-hydroxyquinoline)-aluminum (Alq₃), and organic pigments emitting fluorescence such as coumarin compounds or the like.

Examples of a material for the electron injection-transport layer 28 are oxadiazole derivatives such as 2-(4-biphenyl)-5-(4-tert-butylphenyl)-1,3,4-oxadiazole, 2,5-bis(1-naphtyl)-1,3,4-oxadiazole or the like. Other than those, perylene derivatives, pyridine derivatives, pyrimidine derivatives, quinoline derivatives, quinoxaline derivatives, diphenyl quinone derivatives, nitro-substituted fluorene derivatives, lithium fluorides, lithium oxides, lithium complexes or the like may be also used as the material for the electron injection-transport layer.

The organic functional layer is not limited to the above-described four-layer structure. For example, the organic functional layer may be a single layer structure consisting of the light-emitting layer only, a double layer structure consisting of the hole transport layer and the light-emitting layer, or a multilayer structure wherein an electron or hole injection layer, an electron or hole transport layer, a carrier block layer or the like are inserted between appropriate layers of the two layer structure.

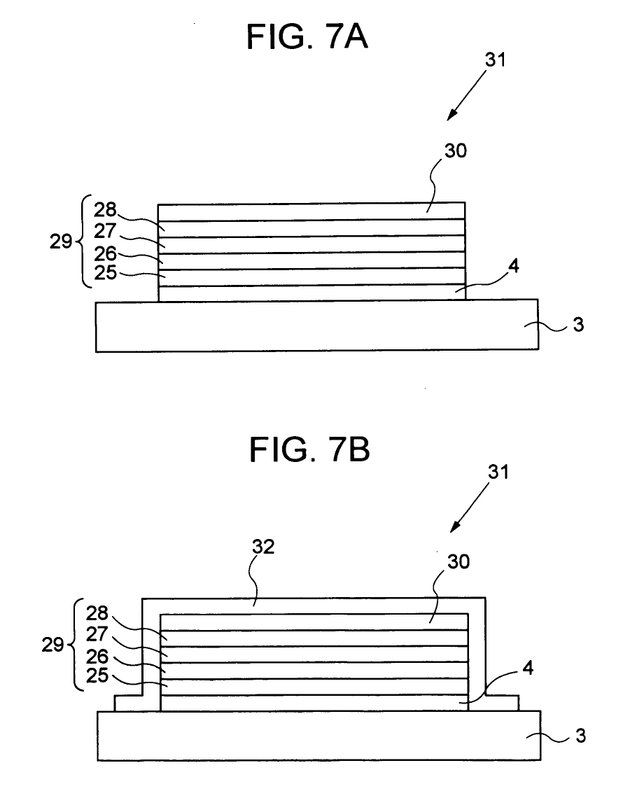

After the formation of the organic functional layer 29, a cathode layer 30 is made of a electro conductive material having a small work function is formed by vapor deposition (FIG. 7A). Examples of a material for the cathode layer 30 are alkaline earth metals such as magnesium, alkali metals such as lithium, aluminum, indium, silver, or alloys of thereof or the like. The multilayer structure having the cathode layer 30 serves an organic EL device 31.

As shown in FIG. 7B, the organic EL device 31 is covered with a seal layer 32 having characteristics that prevents passage of gases such as moisture, i.e., a gas-barrier characteristics. The seal layer 32 is formed by plasma CVD, for example. The seal layer 32 may be made of an inorganic material such as nitride, oxide and nitride oxide. For example, silicon nitride, silicon oxide, or silicon nitride oxide may be used as the material for the seal layer 32. In addition, a seal can may be used in place of the seal layer 32.

According to performing the aforementioned plasma process before the formation of the organic functional layer, it is possible to remove contaminants from the surface of the anode layer and modify the anode layer. Thus, an organic EL device having high luminance and driving at a low voltage for a long time can be fabricated.

In addition to the aforementioned plasma process, a step of performing at least one of a heating process, a UV/ozone process, and an excimer process may be performed. Such a step may be performed before or after the plasma process, or before and after the plasma process.

The heating process heats the surface of the anode layer at a temperature of 100° C. or higher. Usable of a heating methods are a resistance heating, an induction heating, a dielectric heating, and a microwave heating can be used, for example. The resistance heating uses heat generation by electric conductor through which a current is made to flow. In resistance heating, heating unit such as a heater (hot plate) can be used. The induction heating uses temperature increase of a material caused by an induced current from a coil connected to an AC power supply having a frequency of several kilohertz to several megahertz. The dielectric heating uses a temperature increase of insulative material placed in an AC electric field of several megahertz to several tens of megahertz (13.56 MHz, 27.12 MHz, 40.68 MHz, for example), that is caused by electric loss (dielectric loss). The microwave heating is generated by friction due to molecular vibration caused by penetrating an electric field of a microwave of several hundreds of megahertz to several hundreds of gigahertz (for example, 2.45 GHz, 28 GHz) into a dielectric substance. The above-mentioned heating can remove moisture included in the anode layer.

It is more preferable to use induction heating, dielectric heating or microwave heating than resistance heating for the following reason. The resistance heating is an indirect heating method wherein the heat generated by supplying a current to electric conductor is transmitted to the substrate by radiation or the like, thereby heating the anode layer. On the other hand, induction heating, dielectric heating, and microwave heating are direct heating methods wherein the substrate and/or the anode layer generate(s) heat. In other words, as compared with the indirect heating method, the direct heating method can heat the anode layer uniformly in a shorter time without relying on heat conduction of the material and therefore uses the heat more efficiently.

The UV/ozone process is achieved by irradiating the substrate with UV light under the presence of oxygen. As a source of UV light, a mercury lamp and a deuterium lamp that can emit UV light having a wavelength in a range of 150 nm to 350 nm may be used, for example. When the substrate is irradiated with UV light, oxygen is decomposed by the UV light so as to generate ozone and active oxygen. Ozone and active oxygen thus generated react with contaminants such as residue of the resist on the surface of the anode layer. Those contaminants are removed due to this reaction. Moreover, ozone and active oxygen thus generated also react with the material of the anode layer so as to cause modification of the anode layer, such as oxidization of the anode layer. An ionization potential of the anode layer is increased due to the oxidation.

The excimer process is achieved by exposing the substrate to light from an excimer lamp under the presence of oxygen. An excimer lamp using dielectric-barrier discharge driven excimer can be used as the excimer lamp. It is preferable that light emitted from the excimer lamp have a wavelength of 310 nm or shorter. As a discharge gas, KrCl, Xe, XeCl may be used, for example. Especially, an excimer lamp using Xe gas emits light having an emission center wavelength at 172 nm. Light of that wavelength can cause generation of ozone. Therefore, it is preferable to use the excimer lamp using Xe gas.

When the substrate is exposed to the light from the excimer light, that light decomposes oxygen into ozone and active oxygen. Ozone and active oxygen thus generated react with contaminants such as residue of the resist on the anode layer. The contaminants are decomposed by that reaction, so as to be removed. Moreover, ozone and active oxygen also react with the material for the anode layer so as to cause modification of the anode layer, such as oxidization of the anode layer. Such oxidization increases an ionization potential of the anode layer.

As described above, the heating process, the UV/ozone process, and the excimer process can remove contaminants chemically. Therefore, by combining at least one of the heating process, the UV/ozone process, and the excimer process with the aforementioned plasma process, contaminants on the anode layer, especially organic contaminants, can be removed efficiently.

In the above embodiment, the plasma process is performed for the anode layer of the organic EL device. However, the present invention is not limited thereto. The plasma process may be performed for the cathode layer.

The above embodiment is described with reference to an organic EL device as an exemplary electric device in which an organic functional layer being made of an organic material and having a predetermined function is formed to be in contact with an electrode material layer formed of a conductive material. However, the present invention is not limited thereto. For example, the plasma processing method and the plasma processing apparatus according to the present invention can be applied to an organic thin-layer transistor in a similar way.

(Example)

After an ITO layer had been deposited on a glass substrate by sputtering, resist having a predetermined pattern was formed on the ITO layer and then the ITO layer was etched by dry etching using the resist as a mask. Then, the resist was removed so as to obtain an anode layer formed by the ITO layer having a pattern. Then, the glass substrate having the thus formed anode layer was carried into a vacuum chamber of a parallel-plate type plasma processing apparatus of an anode coupling method as shown in FIG. 1. The substrate was placed on the first electrode of the vacuum chamber. As a plasma processing gas, a mixed gas of oxygen and argon (O₂/Ar) was supplied to the inside of the chamber. Then, a high-frequency voltage of 13.56 MHz was applied to the mixed gas introduced into the vacuum chamber, so that oxygen plasma was generated. A plasma process was performed by exposing the anode layer to that oxygen plasma.

After the plasma process had been performed, a hole injection layer, a hole transport layer, a light-emitting layer, and an electron injection-transport layer were sequentially deposited on the anode layer in that order. Then, on an organic functional layer formed by the hole injection layer, the hole transport layer, the light-emitting layer, and the electron injection-transport layer, a cathode layer made of aluminum was deposited by vapor deposition, thereby an organic EL device was formed. Finally, a silicon nitride layer was deposited to cover the organic EL device by using a plasma CVD apparatus, thereby sealing the organic EL device.

(Comparative Example)

Except that the plasma process for the anode layer was performed by using a parallel-plate type plasma processing apparatus of a cathode coupling method, an organic EL device was formed by a procedure approximately the same as that in Example.

(Evaluation)

Evaluation was performed by measuring a work function of the anode layer and a relationship between a voltage applied to the organic EL device and the luminance.

The result of measurement of the work function is shown in Table 1.

TABLE 1

| | Example | Comparative Example |
|---|---|---|
| Work function (eV) | 5.58 | 5.35 |

As is apparent from Table 1, the work function in Example was larger than that in Comparative Example. As the work function of the anode layer became larger, the ionization potential of the anode layer came closer to that of the hole transport material. This is advantageous to injection of carriers. From the above measurement result, it was confirmed that the anode coupling method was able to enhance the efficiency of injection of holes, as compared with the cathode coupling method.

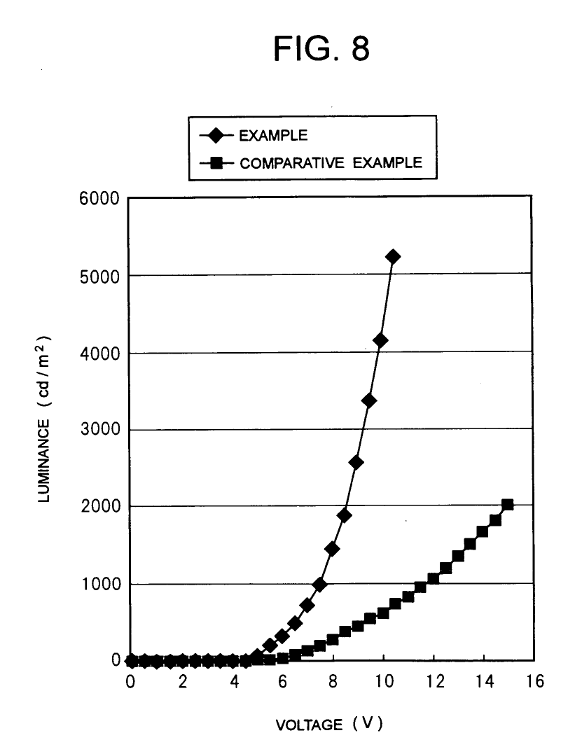

FIG. 8 shows the relationship between the voltage applied to the organic EL device and its luminance. As shown in the graph of FIG. 8, for the organic EL device of Example, when the applied voltage was 10V, the luminance was 4150 cd/cm². On the other hand, for the organic EL device of Comparative Example, when the applied voltage was 10 V, the luminance was 620 cd/cm². Thus, it was confirmed that the fabrication method of the present invention was able to fabricate an organic EL device that had high luminance and was able to be driven at a lower voltage.

The plasma processing method of the present invention for performing a plasma process for a surface of an electrode material layer to be contact in an organic functional layer, includes: a placing process for placing the electrode material layer between a pair of electrodes formed in a vacuum chamber; a gas supply process for supplying a plasma processing gas into the vacuum chamber; and a electric field setting process for applying a main AC voltage superimposed on a reference voltage to one of the pair of electrodes via a capacitor and for keeping the other electrode at the reference potential in the vacuum chamber, wherein the placing process having a process for locating the electrode material layer to be closer to the other electrode than to the one electrode. According to the method, it is possible to clean the surface of the first electrode material layer by the plasma process before the organic functional layer is formed. Thus, efficiency of charge injection into the organic functional layer can be improved and a device that can be driven at a lower voltage can be fabricated.

The plasma processing apparatus of the present invention for performing a surface treatment for an electrode material layer to be in contact with an organic functional layer by using plasma, includes: a holding unit for holding an object having the electrode material layer on a surface thereof in a vacuum chamber; a gas supply unit for supplying a plasma processing gas into the vacuum chamber; at least two electrodes provided near the holding unit; and a application unit for applying a main AC voltage across one of the electrodes and a reference potential via a capacitor while keeping the other of the electrodes at the reference potential, wherein the holding unit holds the object in such a manner that the object is located at a position closer to the other electrode. According to the apparatus, a potential difference between the other electrode and the plasma can be made small by connecting a power supply that supplies the main AC voltage, to the one electrode. Thus, incident energy of ions incident on the other electrode can be made small. Therefore, it is possible to perform a plasma process wherein chemical reaction has a large effect on the electrode material layer supported by the other electrode, so that a device having excellent characteristics be able to drive at a lower voltage can be obtained.

This application is based on a Japanese patent application No. 2004-006550 which is hereby incorporated by reference.

1. A plasma processing method for performing a plasma process for a surface of an electrode material layer that is to be in contact with an organic functional layer, comprising:
a placing process for placing said electrode material layer between a pair of electrodes formed in a vacuum chamber;
a gas supply process for supplying a plasma processing gas into said vacuum chamber; and
a electric field setting process for applying a main AC voltage superimposed on a reference voltage to one of said pair of electrodes via a capacitor and for keeping the other electrode at said reference potential in said vacuum chamber, wherein
said placing process including a process for locating said electrode material layer to be closer to said other electrode than to said one electrode.

2. The plasma processing method according to claim 1, wherein
said electric field setting process including a process for applying an additional AC voltage having a lower frequency than a frequency of said main AC voltage between said other electrode and said reference potential.

3. The plasma processing method according to claim 1, wherein
said reference potential is a ground potential.

4. The plasma processing method according to claim 1, wherein
said main AC voltage is on the order of MHz.

5. The plasma processing method according to claim 2, wherein
said additional AC voltage is on the order of KHz to MHz.

6. The plasma processing method according to claim 1, wherein
said one electrode includes a plurality of holes, and said plasma processing gas is supplied to said vacuum chamber via said holes.

7. The plasma processing method according to claim 1, wherein
said plasma processing gas is a mixed gas of oxygen and any one of nitrogen, argon, helium, neon, xenon, and halogen.

8. The plasma processing method according to claim 1, wherein
said organic functional layer includes a light-emitting layer of an organic electroluminescence device.

9. The plasma processing method according to claim 1, wherein
said electrode material layer is made of indium tin oxide or indium zinc oxide.

10. The plasma processing method according to claim 1, further comprising the step of performing at least one of a heating process, a UV/ozone process, and an excimer process for said electrode material layer.

11. A plasma processing apparatus for processing a surface of an electrode material layer that is to be in contact with an organic functional layer by plasma, comprising:
a holding unit for holding an object having said electrode material layer on a surface thereof in a vacuum chamber;
a gas supply unit for supplying a plasma processing gas into said vacuum chamber;
at least two electrodes provided near said holding unit; and
a application unit for applying a main AC voltage across one of said electrodes and a reference potential via a capacitor while keeping the other of said electrodes at said reference potential, wherein
said holding unit holds said object in such a manner that said object is located at a position closer to said other electrode.

12. The plasma processing apparatus according to claim 11, wherein
said application unit applies an additional AC voltage having a lower frequency than a frequency of said main AC voltage across said other electrode and said reference potential.

13. The plasma processing apparatus according to claim 11, wherein
said reference potential is a ground potential.

14. The plasma processing apparatus according to claim 11, wherein
a frequency of said main AC voltage is on the order of MHz.

15. The plasma processing apparatus according to claim 12, wherein
said frequency of said additional AC voltage is on the order of KHz to MHz.

16. The plasma processing apparatus according to claim 11, wherein
said one electrode includes a plurality of holes, and
said gas supply unit supplies said plasma processing gas into said vacuum chamber via said holes.
